(19) United States
(12) Patent Application Publication
(10) Pub. No.: US 2007/0050513 A1
(43) Pub. Date: Mar. 1, 2007

(54) Image forming device for data transmission using FTP and method thereof

(75) Inventor: Won-ho Song, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/492,098

(22) Filed: Jul. 25, 2006

(30) Foreign Application Priority Data
Aug. 31, 2005 (KR) 10-2005-0081019

(51) Int. Cl. G06F 15/16

(52) U.S. Cl. 709/230

(57) ABSTRACT

An image forming device for data transmission using FTP and a method thereof are provided, and include a storing unit for storing input data divided by at least one operation type according to a user preference, an FTP transmission unit for requesting authentication by transmitting certain authentication information to a destination device and transmitting the data to the destination device using the FTP, and a controlling unit for controlling the FTP transmission unit and the storing unit to perform an operation for the data according to the operation type. Accordingly, data transmission/reception and management using FTP can be easily performed.

### CROSS-REFERENCE TO RELATED APPLICATIONS

This application claims the benefit under 35 U.S.C. §119(a) of Korean Patent Application No. 10-2005-0081019, filed in the Korean Intellectual Property Office on Aug. 31, 2005, the entire disclosure of which is incorporated herein by reference.

### BACKGROUND OF THE INVENTION

1. Field of the Invention

The present invention relates to an image forming device for data transmission using FTP and a method thereof. More particularly, the present invention relates to an image forming device for data transmission using FTP to facilitate various operations for data and a method thereof.

2. Description of the Related Art

As various input/output devices are used according to advancements in office automation, laser beam printers, light emitting diode (LED) print head (LPH) printers, copying machines, facsimiles or the like, are becoming generically known as image forming devices.

The conventional image forming device had one function in one device such as a printer, copying machine or the like. However, as digital technology develops, the multi-function printer (MFP) having the various functions of a printer, scanner, facsimile and so forth, in one device has developed.

The MFP has the unique functions of an image forming apparatus such as a printing function and scanning function, and also includes data transmission/reception functions via various communication modules.

In addition, the conventional image forming device had a small amount of memory for temporarily storing data received from a host device until output. However, recently image forming devices have included mass storage, such as hard disk drives (HDD) commonly associated with a host device.

The file transfer protocol (FTP) system can be constructed using the image forming device with a communication module and mass storage. Therefore, conventionally, only a host device with mass storage could function as an FTP server. However, with the above described developments, the image forming device can function as an FTP server.

As an image forming device with mass storage can function as an FTP server, data can be stored and managed in the image forming device rather than in the host device.

However, an FTP system using the conventional image forming device is just for utilizing mass storage media formed in the image forming device so that there is a problem in that other functions of the image forming device can not be utilized together.

Accordingly, a need exists for a system and method for data transmission using FTP to facilitate various operations in an image forming device.

### SUMMARY OF THE INVENTION

An aspect of embodiments of the present invention is to substantially solve at least the above problems and/or disadvantages and to provide at least the advantages described below. Accordingly, an aspect of embodiments of the present invention is to provide an image forming device for data transmission using FTP and a method thereof to facilitate various operations by storing data divided by an operation type in the image forming apparatus with FTP functions.

In order to achieve the above-described aspects of embodiments of the present invention, an image forming device is provided for data transmission using file transfer protocol (FTP), comprising a storing unit for storing input data divided by at least one operation type according to a user preference, an FTP transmission unit for requesting authentication by transmitting certain authentication information to a destination device and transmitting the data to the destination device using the FTP, and a controlling unit for controlling the FTP transmission unit and the storing unit to perform an operation for the data according to the operation type.

The controlling unit may control the image forming device to perform the operation for the data if the authentication is approved from the destination device.

The storing unit may comprise a folder corresponding to each operation type and can store the data in the folder according to the operation type to be performed, and an attribute of the folder may comprise information on the destination device to transmit the data stored in the folder.

The controlling unit may control the FTP transmission unit and the storing unit to perform operations corresponding to the folder storing the data if the folder corresponding to the operation type stores the data.

The operation types may comprise “FTP transmission after storing”, “only FTP transmission”, and “FTP transmission after storing and temporarily keeping”, but are not limited thereto.

If the operation type is the “FTP transmission after storing”, the controlling unit controls the FTP transmission unit to transmit the data stored in the storing unit to the destination device. If the operation type is the “only FTP transmission”, the controlling unit controls the FTP transmission unit to transmit the data stored in the storing unit to the destination device and deletes the data stored in the storing unit. If the operation type is the “FTP transmission after storing and temporarily keeping”, the controlling unit controls the FTP transmission unit to transmit the data stored in the storing unit to the destination device and deletes the data stored in the storing unit after a preset time.

The data stored in the storing unit after being transmitted by the FTP transmission unit may be transmitted using FTP according to a user preference.

The image forming device may further comprise a scanning unit for scanning documents to generate data, and wherein the storing unit stores the data generated by the scanning unit divided by the operation types according to a user preference.

The image forming device may further comprise a user input unit for receiving a user preference by the user.

The image forming device may further comprise an authentication unit for determining whether to approve authentication based on the authentication information transmitted from an external device.

In order to achieve the above-described aspects of embodiments of the present invention, a method of data transmission of an image forming device is provided to transmit and receive data using FTP and comprises storing the data divided by at least one operation type according to a user preference, requesting authentication by transmitting certain authentication information to a destination device, and performing operation for the data according to the operation type.

The step of performing the operation may control the image forming device to perform the operation for the data if the authentication is approved from the destination device.

The storing step may store the data in a folder corresponding to the operation type to be performed. An attribute of the folder may comprise information on the destination device to transmit the data stored in the folder.

The step of performing the operation may perform operations corresponding to the folder storing the data if the folder corresponding to the operation type stores the data.

The operation types may comprise “FTP transmission after storing”, “only FTP transmission”, and “FTP transmission after storing and temporarily keeping”. If the operation type is the “FTP transmission after storing”, the step of performing the operation transmits the stored data to the destination device. If the operation type is the “only FTP transmission”, the step of performing the operation transmits the data stored in the storing unit to the destination device and deletes the stored data. If the operation type is the “FTP transmission after storing and temporarily keeping”, the step of performing the operation transmits the stored data to the destination device and deletes the stored data after a preset time.

The method may further comprise transmitting the data stored in the storing unit using FTP according to a user preference after the step of performing the operation.

The method may further comprise scanning documents to generate data, and wherein the storing step stores the generated data by operation types according to the user preference.

### BRIEF DESCRIPTION OF THE DRAWING FIGURES

The above aspects and other features of embodiments of the present invention will become more apparent by describing in detail exemplary embodiments thereof with reference to the attached drawing figures, wherein;

FIG. 1 is a block diagram of an exemplary image forming device using FTP according to an embodiment of the present invention; and

FIG. 2 is a flow chart describing an exemplary method of data transmission of an image forming device using FTP according to an embodiment of the present invention.

Throughout the drawings, like reference numerals will be understood to refer to like parts, components and structures.

### DETAILED DESCRIPTION OF THE EXEMPLARY EMBODIMENTS

Hereinafter, exemplary embodiments of the present invention will be described in detail with reference to the accompanying drawing figures.

In the following description, same drawing reference numerals are used for the same elements even in different drawings. The matters defined in the description, such as detailed construction and elements, are provided to assist in a comprehensive understanding of the invention. Also, well-known functions or constructions are not described in detail since they would obscure the invention in unnecessary detail.

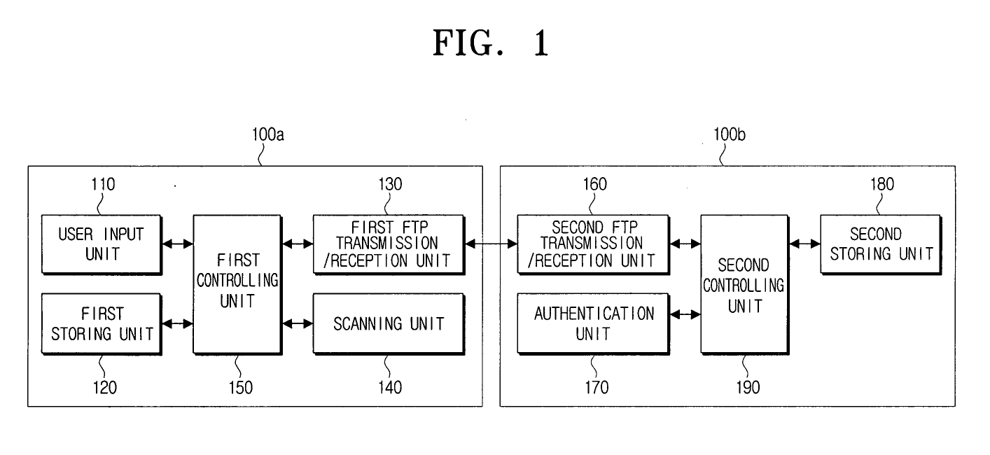

FIG. 1 is a block diagram of an image forming device using FTP according to an exemplary embodiment of the present invention. In an illustrative embodiment of the present invention, an image forming device is illustrated as divided into a transmission device 100a and a destination device 100b to help in understanding operations thereof.

The transmission device 100a comprises a user input unit 110, a first storing unit 120, a first FTP transmission/reception unit 130, a scanning unit 140, and a first controlling unit 150. Also, the transmission device 100a further comprises units for basic functions to form images such as a printing unit as known to those skilled in the art, therefore detailed descriptions thereof are omitted.

The user input unit 110 can receive a certain input signal from a user and provide the signal to the first controlling unit 150. According to an embodiment of the present invention, the signal input through the user input unit 110 comprises an operation type for data, and authentication information to be authenticated from the destination device, that is, a user ID and a password.

The first storing unit 120 stores input data divided by at least one operation type according to the user preference. The data may be data scanned through the scanning unit 140.

The operation types may comprise “FTP transmission after storing”, “only FTP transmission”, and “FTP transmission after storing and temporarily keeping”. The “FTP transmission after storing” stores data in the first storing unit 120 and transmits the data to the destination device using FTP. In addition, “only FTP transmission” transmits data to the destination device using FTP and deletes the data stored in the first storing unit 120 such that the data is not kept. Further, “FTP transmission after storing and temporarily keeping” stores data in the first storing unit 120, transmits the data to the destination device using FTP, and deletes the data stored in the first storing unit 120 after a preset time to thereby keep the data for a certain amount of time.

Preferably, folders corresponding to the operation types can be generated in the first storing unit 120. For example, the first storing unit 120 generates folders of “FTP transmission after storing”, “only FTP transmission” and “FTP transmission after storing and temporarily keeping”, and the operations corresponding to data stored in the each of the folders are set. Folder names and the number of folders are not limited to this example. If necessary, folder names can be changed and any number of folders can be generated or deleted.

In addition, an attribute of each folder of the first storing unit 120 may comprise information on the destination device to transmit the data stored in folder, that is, an Internet protocol (IP) address. As described above, if the first storing unit 120 consists of the folders, the data is stored in the folder corresponding to an operation type to be performed according to the user preference.

The first storing unit 120 stores authentication information to be used upon requesting permission of each destination device preset by a user. The first storing unit 120 can provide the authentication information to the first FTP transmission/reception unit 130 by control of the first controlling unit 150.

The data transmitted using FTP is stored in the first storing unit 120 and can be re-transmitted using FTP according to the user preference.

The first FTP transmission/reception unit 130 transmits the data stored in the first storing unit 120 to the destination device using FTP. The data is transmitted by the first FTP transmission/reception unit 130 to the IP address of the corresponding destination device input in the attribute of the folder of the first storing unit 120 where the data is stored.

The first FTP transmission/reception unit 130 requests authentication by transmitting the authentication information stored in the first storing unit 120 to receive permission from the destination device before data transmission. The authentication information can be previously stored in the first storing unit 120 or can be input through the user input unit 110 by a user.

The first FTP transmission/reception unit 130 requests authentication by transmitting the ID and password stored in the first storing unit 120 if the destination device needs authentication due to limited permission, and the first FTP transmission/reception unit 130 requests authentication by transmitting “anonymous” as the ID if the destination device does not need authentication.

The scanning unit 140 generates data by scanning documents provided by a user in a general method. Preferably, the data generated by the scanning unit 140 can be stored in a certain folder of the first storing unit 120 by the user preference through the user input unit 110.

The first controlling unit 150 controls the overall functions of the transmission device 100a and specifically controls signal input and output among the user input unit 110, first storing unit 120, first FTP transmission/reception unit 130, and scanning unit 140.

The first controlling unit 150 controls the first FTP transmission/reception unit 130 and first storing unit 120 to perform an operation corresponding to data stored in the first storing unit 120. That is, the first controlling unit 150 controls the first FTP transmission/reception unit 130 and first storing unit 120 to perform an operation corresponding to data included in a particular folder of the first storing unit 120.

More specifically, when data is in the “FTP transmission after storing” folder, the first controlling unit 150 controls the first FTP transmission/reception unit 130 to transmit the data to the IP address of the destination device input in the attribute of the “FTP transmission after storing” folder, and controls the first storing unit 120 to maintain the data.

Additionally, when data is in the “only FTP transmission” folder, the first controlling unit 150 controls the first FTP transmission/reception unit 130 to transmit the data to the IP address of the destination device input in the attribute of the “only FTP transmission” folder, and controls the first storing unit 120 to delete the data stored in the first storing unit 120.

Additionally, when data is in the “FTP transmission after storing and temporarily keeping” folder, the first controlling unit 150 controls the first FTP transmission/reception unit 130 to transmit the data to the IP address of the destination device input in the attribute of the “FTP transmission after storing and temporarily keeping” folder, and controls the first storing unit 120 to keep the data stored in the first storing unit 120 during a preset time and to then delete the data after the preset time expires.

If the first controlling unit 150 receives data scanned by the scanning unit 140, the data is stored in the first storing unit 120. At this moment, a user can select a folder corresponding to the desired operation among the folders of “FTP transmission after storing”, “only FTP transmission” and “FTP transmission after storing and temporarily keeping” in which the data is to be stored.

The destination device 100b comprises a second FTP transmission/reception unit 160, an authentication unit 170, a second storing unit 180, and a second controlling unit 190.

The second FTP transmission/reception unit 160 receives authentication information and data transmitted from the transmission device 100a using FTP, and transmits the information and data to the second controlling unit 190.

The authentication unit 170 determines whether to approve authentication in the destination device 100b by the authentication information transmitted from an external device, that is, the transmission device 100a. Due to the authentication unit 170, the destination device 100b functions as an FTP server to allow data transmission only when authentication is approved.

The second storing unit 180 comprises mass storage to store multiple data. According to an embodiment of the present invention, the second storing unit 180 stores the data received through the second FTP transmission/reception unit 160.

The second controlling unit 190 controls the overall functions of the destination device 100b. That is, the second controlling unit 190 controls signal input and output among the second FTP transmission/reception unit 160, the authentication unit 170, and the second storing unit 180.

After the authentication unit 170 determines whether to approve authentication, the second controlling unit 190 controls the second FTP transmission/reception unit 160 to transmit the approval result to the transmission device 100a. In addition, if the second FTP transmission/reception unit 160 receives the data, the second controlling unit 190 controls the received data to be stored in the second storing unit 180.

As described above, the transmission device 100a controls the first FTP transmission/reception unit 130 to transmit data using FTP so that the transmission device 100a functions as an FTP client to upload or download data to an FTP server.

Additionally, the destination device 100b controls the second storing unit 180 of mass storage and the authentication unit 170 so that the destination device 100b functions as an FTP server to transmit and receive data only when authentication is approved.

In embodiments of the present invention, the transmission device 100a and the destination device 100b have been illustrated and described as divided for convenience, but their functions and/or features can be included in a single device.

The functions of the first storing unit 120 and the first FTP transmission/reception unit 130 in the transmission device 100a substantially correspond to the functions of the second storing unit 180 and the second FTP transmission/reception unit 160 in the destination device 100b so that with different constructions included, one image forming device can function as an FTP server or an FTP client according to the circumstances.

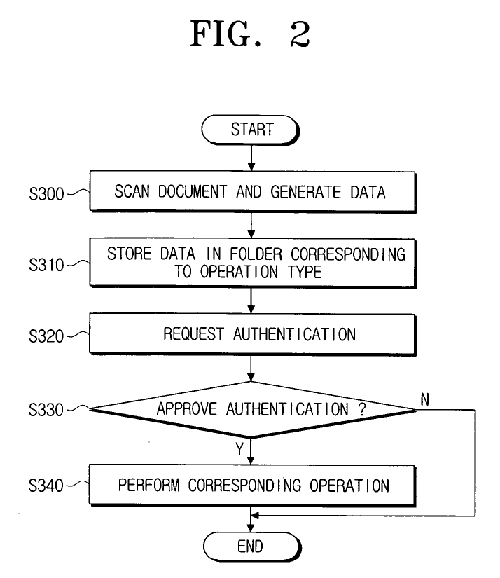

FIG. 2 is a flow chart describing an exemplary method of data transmission of an image forming device using FTP according to an embodiment of the present invention.

Referring to FIG. 1 and FIG. 2, a method of data transmission of an image forming device using FTP according to an embodiment of the present invention is described.

When a user inserts a document in the scanning unit 140 of the transmission device 100a, the scanning unit 140 scans the document to generate data at step (S300). The case where data is scanned and input through the scanning unit 140 is explained as an example, but data can be transmitted and input from an external device, that is, from any of plural image forming devices or other devices.

If the user specifies a folder to store the data among the folders of “FTP transmission after storing”, “only FTP transmission” and “FTP transmission after storing and temporarily keeping” according to the operation type to perform, the data is stored in the specified folder of the first storing unit 120 at step (S310).

The first FTP transmission/reception unit 130 can then request authentication of permission by transmitting authentication information corresponding to the destination device 100b stored in the first storing unit 120 to the destination device 100b by control of the first controlling unit 150 at step (S320).

If the destination device 100b receives the authentication information from the transmission device 100a, the destination device 100b determines whether to approve authentication for the transmission device 100a based on whether received authentication information corresponds to the preset authentication information at step (S330).

In (S330), if the destination device 100b approves authentication, the first controlling unit 150 controls the first FTP transmission/reception unit 130 and the first storing unit 120 to perform the operation corresponding to the folder where the data is stored at step (S340).

As described above, an image forming device for data transmission using FTP and a method thereof according to embodiments of the present invention can be used for data transmission using FTP to facilitate various operations in the image forming device. For example, if it is assumed that the transmission device 100a having data supports black and white printing and the first storing unit 120 has a “color printing” folder, an attribute of the “color printing” folder has an IP address of an image forming device supporting color printing. If the data is stored in the “color printing” folder by the user preference, the first FTP transmission/reception unit 130 transmits the data to the image forming device supporting color printing. The user can then get the color-printed outcome from the image forming device supporting color printing.

As can be appreciated from the above description, the image forming device for data transmission using FTP and the method thereof according to embodiments of the present invention facilitates various operations such as FTP transmission and storage by storing data divided by an operation in the image forming apparatus with FTP functions.

Also, the image forming device has functions of FTP transmission, mass storage and permission authentication, and can function as both an FTP server and FTP client according to the circumstances, so that efficiency of the image forming device can increase.

While the present invention has been shown and described with reference to certain exemplary embodiments thereof, it will be understood by those skilled in the art that various changes in form and details may be made therein without departing from the spirit and scope of the invention as defined by the appended claims.

What is claimed is:

1. An image forming device for data transmission and reception using file transfer protocol (FTP), comprising:
a storing unit for storing input data divided by at least one operation type according to a user preference;
an FTP transmission unit for requesting authentication by transmitting certain authentication information to a destination device and transmitting the data to the destination device using the FTP; and
a controlling unit for controlling the FTP transmission unit and the storing unit to perform an operation for the data according to the operation type.

2. The image forming device of claim 1, wherein the controlling unit is configured to control the device to perform the operation for the data if the authentication is approved from the destination device.

3. The image forming device of claim 1, wherein the storing unit comprises:
at least one folder corresponding to each operation type and is configured to store the data in the folder according to the operation type to be performed, and
wherein an attribute of the folder comprises information on the destination device to transmit the data stored in the folder.

4. The image forming device of claim 3, wherein the controlling unit is configured to control the FTP transmission unit and the storing unit to perform operations corresponding to the folder storing the data, if the folder corresponding to the operation type stores the data.

5. The image forming device of claim 1, wherein the operation types comprise “FTP transmission after storing”, “only FTP transmission”, and “FTP transmission after storing and temporarily keeping”.

6. The image forming device of claim 5, wherein:
if the operation type is the “FTP transmission after storing”, the controlling unit is configured to control the FTP transmission unit to transmit the data stored in the storing unit to the destination device,
if the operation type is the “only FTP transmission”, the controlling unit is configured to control the FTP transmission unit to transmit the data stored in the storing unit to the destination device and delete the data stored in the storing unit, and
if the operation type is the “FTP transmission after storing and temporarily keeping”, the controlling unit is configured to control the FTP transmission unit to transmit the data stored in the storing unit to the destination device and delete the data stored in the storing unit after a preset time.

7. The image forming device of claim 6, wherein the data stored in the storing unit after being transmitted by the FTP transmission unit is transmitted using FTP according to a user preference.

8. The image forming device of claim 1, further comprising:
a scanning unit for scanning documents to generate data, and
wherein the storing unit is configured to store the data generated by the scanning unit divided by the operation types according to a user preference.

9. The image forming device of claim 8, further comprising:
a user input unit for receiving the user preference by the user.

10. The image forming device of claim 1, further comprising:
an authentication unit for determining whether to approve authentication based on the authentication information transmitted from an external device.

11. A method of controlling data transmission and reception of an image forming device using file transfer protocol (FTP), comprising:
storing data divided by at least one operation type according to a user preference;
requesting authentication by transmitting certain authentication information to a destination device; and
performing operations for the data according to the operation type.

12. The method of claim 11, wherein the step of performing the operation comprises:
controlling the device to perform the operation for the data if the authentication is approved from the destination device.

13. The method of claim 11, wherein the storing step comprises:
storing the data in the folder corresponding to the operation type to be performed.

14. The method of claim 13, wherein an attribute of the folder comprises information on the destination device to transmit the data stored in the folder.

15. The method of claim 13, wherein the step of performing the operation comprises:
performing operations corresponding to the folder storing the data, if the folder corresponding to the operation type stores the data.

16. The method of claim 11, wherein the operation types comprise “FTP transmission after storing”, “only FTP transmission”, and “FTP transmission after storing and temporarily keeping”.

17. The method of claim 16, wherein:
if the operation type is the “FTP transmission after storing”, the step of performing the operation transmits the stored data to the destination device,
if the operation type is the “only FTP transmission”, the step of performing the operation transmits the data stored in the storing unit to the destination device and deletes the stored data, and
if the operation type is the “FTP transmission after storing and temporarily keeping”, the step of performing the operation transmits the stored data to the destination device and deletes the stored data after a preset time.

18. The method of claim 17, further comprising:
transmitting the data stored in the storing unit using FTP according to the user preference after the step of performing the operation.

19. The method of claim 11, further comprising:
scanning a document to generate data, and
wherein the storing step stores the generated data divided by operation types according to the user preference.
